(19) United States
(12) Patent Application Publication
(10) Pub. No.: US 2015/0138078 A1
(43) Pub. Date: May 21, 2015

(54) HAND POSE RECOGNITION USING BOOSTED LOOK UP TABLES

(71) Applicants: Eyal Krupka, Shimshit (IL); Alon Vinnikov, Ramat Gan (IL); Benjamin Eliot Klein, Tel Aviv (IL); Szymon P. Stachniak, Redmond, WA (US)

(72) Inventors: Eyal Krupka, Shimshit (IL); Alon Vinnikov, Ramat Gan (IL); Benjamin Eliot Klein, Tel Aviv (IL); Szymon P. Stachniak, Redmond, WA (US)

(21) Appl. No.: 14/546,750

(22) Filed: Nov. 18, 2014

Related U.S. Application Data
(60) Provisional application No. 61/905,751, filed on Nov. 18, 2013.

(51) Int. Cl. G06K 9/00; G06K 9/62; G06K 9/46; G06F 3/01

(52) U.S. Cl. CPC G06K 9/00536; G06F 3/017; G06K 9/6256; G06K 9/4647
USPC 345/156

(57) ABSTRACT

Pose and gesture detection and classification of a human poses and gestures using a discriminative ferns ensemble classifier is provided. Sample image data in one or more channels includes a human image. A processing device operates on the sample image data using the discriminative ferns ensemble classifier. The classifier has set of classification tables and matching bit features (ferns) which are developed using a first set of training data and optimized by a weighting of the tables using an SVM linear classifier configured based on the first or a second set of pose training data. The tables allow computation of a score per pose class for the image in the sample data and the processor outputs a determination of the pose in the sample depth image data. The determination enables the manipulation of a natural user interface.

### BACKGROUND

Recently, Natural User Interface (NUI) systems such as the Microsoft Kinect® allow users to control device interactions using poses and gestures. Recognizing hand poses from low resolution infrared (IR) and depth images using very low compute budget is problematic. Many methods which are used for general object recognition and skeleton recognition can be sued to solve this problem, after some tuning and modification. One example of a method suitable for pose recognition is based on Random Forest classification, which classifies each pixel on the hand either as part of the hand and its pose.

### SUMMARY

The technology, briefly described, comprises a method and apparatus for classification of a human hand pose into one of several hand pose categories from image data. The sample image data may be provided by a capture device having one or more input channels. A processing device operates on the sample image data using a discriminative ferns ensemble (DFE) classifier having direct indexing to a set of classification tables, the tables developed using a first set of training data and optimized by a weighting of the tables using a Support Vector Machines (SVM) linear classifier configured based on a second set of pose training data. The tables allow to compute a confidence score per pose class for the image in the sample data and the processor outputs a determination of the pose in the sample depth image data. The determination enables, for example, the manipulation of a natural user interface.

In another aspect, a computer implemented method of classifying sample image data to determine a gesture present in the sample image data is provided. The method includes creating a discriminative ferns ensemble classifier having direct indexing to a set of classification tables (or ferns). The tables are developed using a learned model based on a first set of pose training data and optimized by a weighting of the tables using an SVM linear classifier based on a second set of pose training data. The method includes receiving sample image data to be classified from a capture device. The capture device may include a first input channel and a second input channel. The sample image data is analyzed using the discriminative ferns ensemble classifier. A determination of the gesture in the depth image data, the determination enables a manipulation of a natural user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flowchart depicting a first embodiment of a method in accordance with the present technology.

FIG. 2 is a flowchart depicting one embodiment of a classifier in accordance with the present technology.

FIG. 3 illustrates image data comprising various hand poses comprising classifications of “Open”, “Closed,” “Lasso” and “Other” as used herein.

FIG. 4A is a table illustrating error for several DFE and ferns algorithm variations.

FIG. 4B is a graph illustrating a false negative rate of the DFE as a function of K.

FIG. 4C is a graph illustrating a false negative rate as a function of M for several training procedures.

FIG. 5A is a graph illustrating the best results of false negative rate under constraint of classification CPU time for various methods and parameters for each method.

FIG. 5B is a graph illustrating accuracy obtained by DFE as a function of training sample size where X axis is the fraction of training set size relative to the full set (420,000 images).

FIG. 5C is a graph illustrating the classification CPU time, as a function of training sample size.

FIG. 6 is a block diagram illustrating a capture device.

FIG. 7 is a block diagram illustrating a console processing device.

FIG. 8 is a block diagram illustrating another embodiment of a processing device.

### DETAILED DESCRIPTION

Technology for pose and gesture detection and classification of a human poses and gestures is provided. Sample image data in one or more channels includes a human image. A processing device operates on the sample image data using a discriminative ferns ensemble (DFE) classifier having direct indexing to a set of classification tables, the tables developed using a first set of training data and optimized by a weighting of the tables using an SVM linear classifier configured based on a second set of pose training data. The tables allow classification of score for the image in the sample data and the processor outputs a determination of the pose in the sample depth image data. The determination enables, for example, the manipulation of a natural user interface. A faster gesture classifier is obtained through a combination of learning words composed of binary features, and learning multiple lookup tables based on histograms of these words. The design of this combination gives significant boost to run time (low CPU) while achieving high accuracy. This is highly desirable in most practical applications of hand pose recognition. The gesture classifier can be used in or in conjunction with a capture device operating in conjunction with a processing device, as described herein.

In applications using a NUI, the technology allows one to obtain high recognition accuracy in real time, on low power platforms. This allows accuracy to be obtained with only a small fraction of the available CPU resources, reserving CPU cycles for other operations.

The technology presented herein allows hand pose classification using, for example, infra-red (IR) and depth images from a time of flight depth camera, in the context of a NUI application. There are dual demands for high accuracy and a very low computation budget, the latter a fraction of a millisecond on a low-end CPU.

The present technology increases speed and accuracy using larger training sets by incorporating using three general principles. First, simple non-invariant features with sharp non-linearity are used as they are fast to compute. Using a large enough training set, the task-relevant invariance will be learned instead of a priori encoded. Second, an architecture with large capacity and minimal computation based on an ensemble of large tables encoding the end results is used. Such table-based classifiers, termed ‘ferns’, have high capacity with a VC-dimension of 2^{K} for a single 2^{K}-entry table, and close to M2^{K} for a M-tables ensemble. Third, a discriminative optimization framework for a fern ensemble is used.

Focusing on speed optimization, spatial aggregates of highly simplistic features, (i.e. pixel-pair comparisons) are used. A lookup table (fern) is then built from a set of such bit features. Instead of a huge single table, a fern ensemble is then learned by the system. Each fern is based on a set of K simple binary features and a large table of 2^{K}-entries. The binary features are concatenated into an index, and the corresponding index entry in the table contains a weight contribution, summed across the ferns to get the final classification. Each table can be regarded as an efficient codeword dictionary: it maps a patch into one of 2^{K} words, at the cost of K operations. The resulting architecture is highly non-linear, and a feed-forward push of an image through it only uses multiple bit computations and table access operations.

Ferns are traditionally formulated generatively, i.e., conditional class probabilities are stored at the table entries. In contrast, the ensemble of the present technology is trained discriminatively by minimizing the regularized hinge loss, i.e., the loss minimized by Support Vector Machines (SVM). It is done agglomeratively in a boosting-like framework, promoting complementariness between chosen ferns and between bits in a single fern.

The technology is alternatively referred to as a Discriminative Ferns Ensemble (DFE) approach. The method is applied to, for example, hand pose recognition from IR and depth images, and achieves accuracy comparable or better than the best known methods while being one to two orders of magnitude faster. Although the examples herein refer specifically to hand pose recognition, it should be recognized that the technology may be applied to alternative forms of visual category recognition. Specifically, the present technology is significantly more accurate than a classification based on deep random trees which have been used for similar tasks, and considerably more accurate than a more standard ensemble of random ferns. When compared to other methods combining fast dense SIFT features, DAISY, random forest dictionaries, and SVM, the best results achieved were slightly less accurate than DFE, but classification time was two orders of magnitude (i.e. 100 times) slower than DFE.

Significant improvements in classification speed—for a given target accuracy—can be achieved by collecting larger training sets. This is done by optimizing K (log of the table size) and M (number of ferns) for a given training set size. In other words, if a DFE classifier is accurate, but not fast enough, collecting larger training set can be used to accelerate classification speed. Note that this trade-off is different from the well-known trade-off between training set size and accuracy.

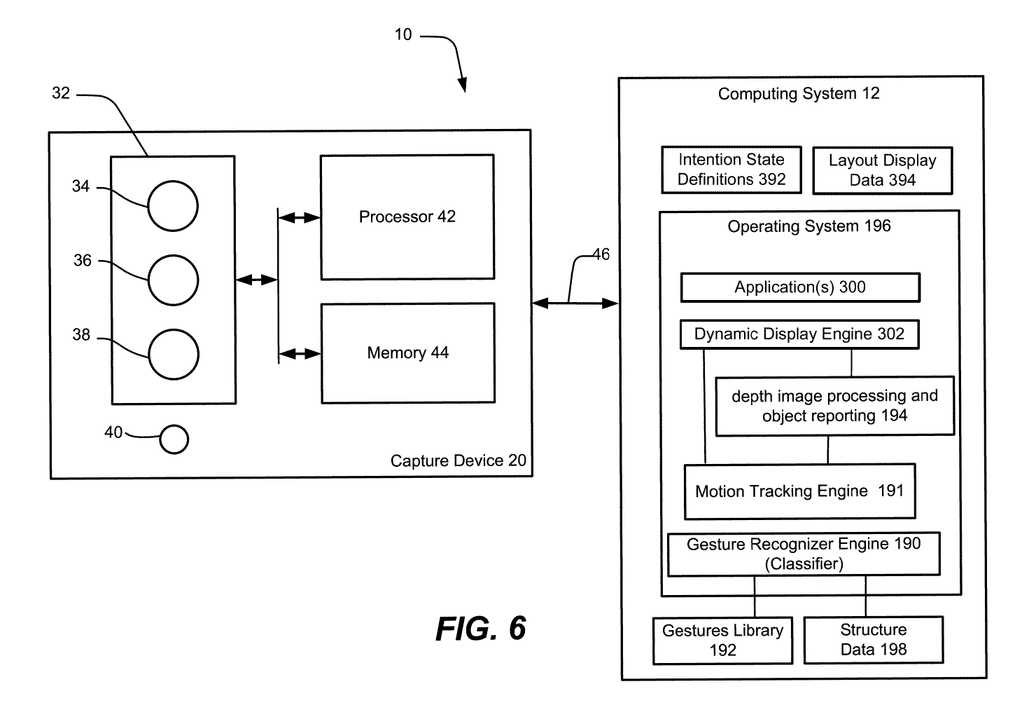

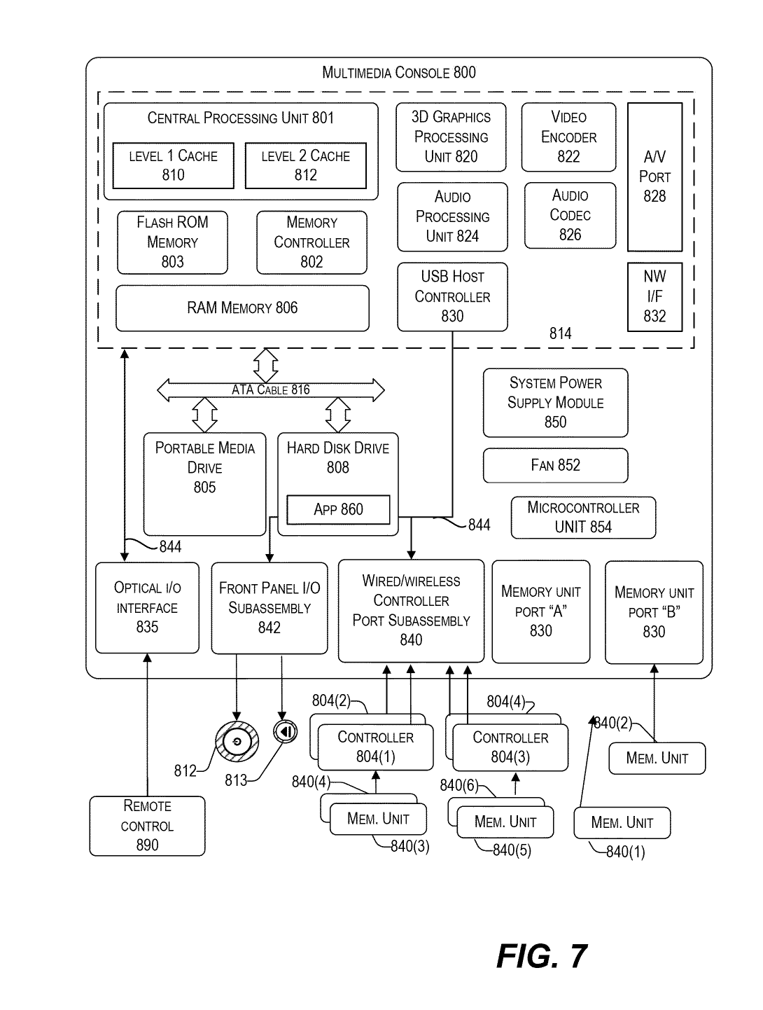

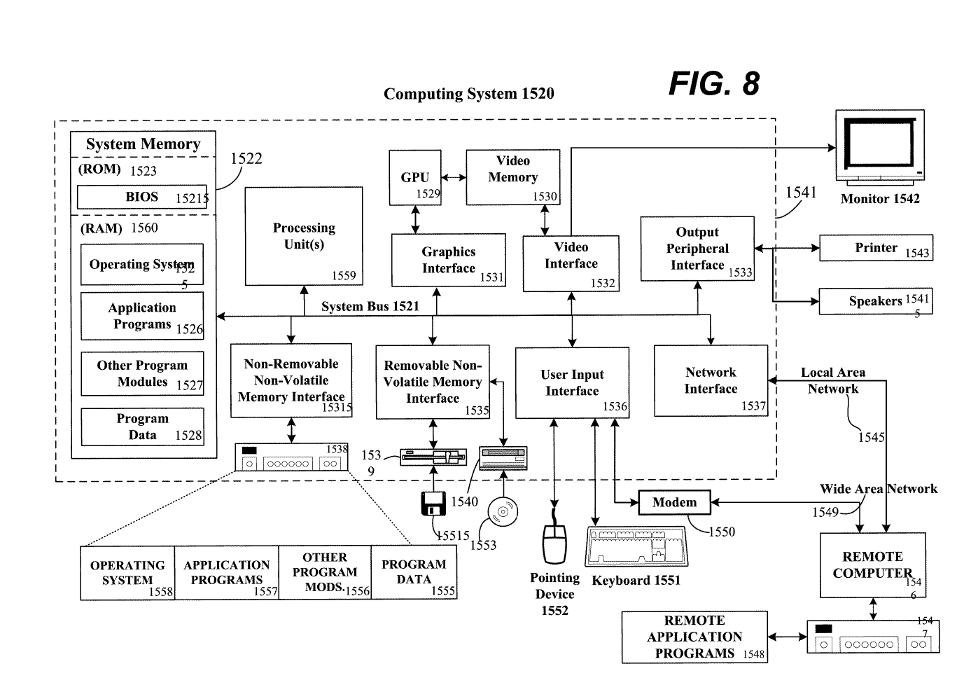

A capture device is illustrated in FIG. 6. The capture device 10 and associated processing devices (FIGS. 7 and 8) may perform the methods described herein. The processing device (processor 42, computing system 12, console 800 or computing system 1520) takes as an exemplary input an image of the hand (palm), of some fixed size (for example, 30×30 pixels). The input may be provided by the capture device 10. The input image can include multiple channels (e.g., IR image and depth image), and may optionally have background removal as a preprocessing stage. (Background removal may comprise clearing all pixels which does not (roughly) match the depth of the hand.) The exact details of preprocessing may vary.

The technology includes learning (training) component which develops a learned model, and a classifier component that uses the learned model to provide a classification of the image data.

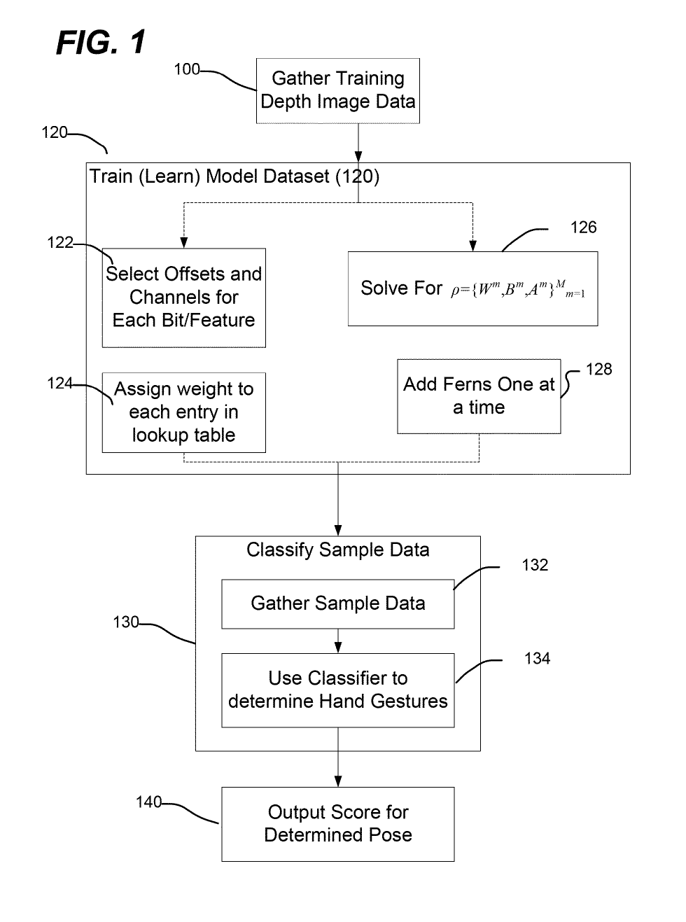

FIG. 1 illustrates an overall method in accordance with the present technology. At step 100, a large set of training data is gathered. Various references to the size of the training sets used in various alternatives of the present technology are referenced herein. At 120, a learning process is performed—two alternatives of the learning process are discussed in accordance with the present technology. In both training alternatives, the learning phase 120 uses a large training set gathered at 100. In a first embodiment (122, 124), the training includes: (1) selecting 122 the offsets and channels for each bit/feature; and (2) assigning 124 weight to each entry of each lookup table. In a discriminative learning alternative, the process for selecting input pixels is different. Using the DFE classifier in equation (5), the method solves for the parameters p={W^{m}, B^{m}, A^{m}}^{M}ₘ₌₁ from a labeled training set {(Iⁱ, yⁱ)}^{N}ᵢ₌₁. At 130, classifier method 130 may be performed using the learned model developed from the training data to classify poses in sample data. Sample data to be classified is gathered at 132 and the classifier applied to determine a hand gesture at 134.

In order to understand the alternative learning component types, the classifier 130 is first described, followed by a description of the training stage 120. The training 120 and classification 130 may be performed by any one or more of the processing devices described herein. In one embodiment, the method discussed herein is performed on a processing device receiving data provided by a capture device (discussed below in FIG. 6), with the classification results provided to one or more applications utilizing a natural user interface (NUI).

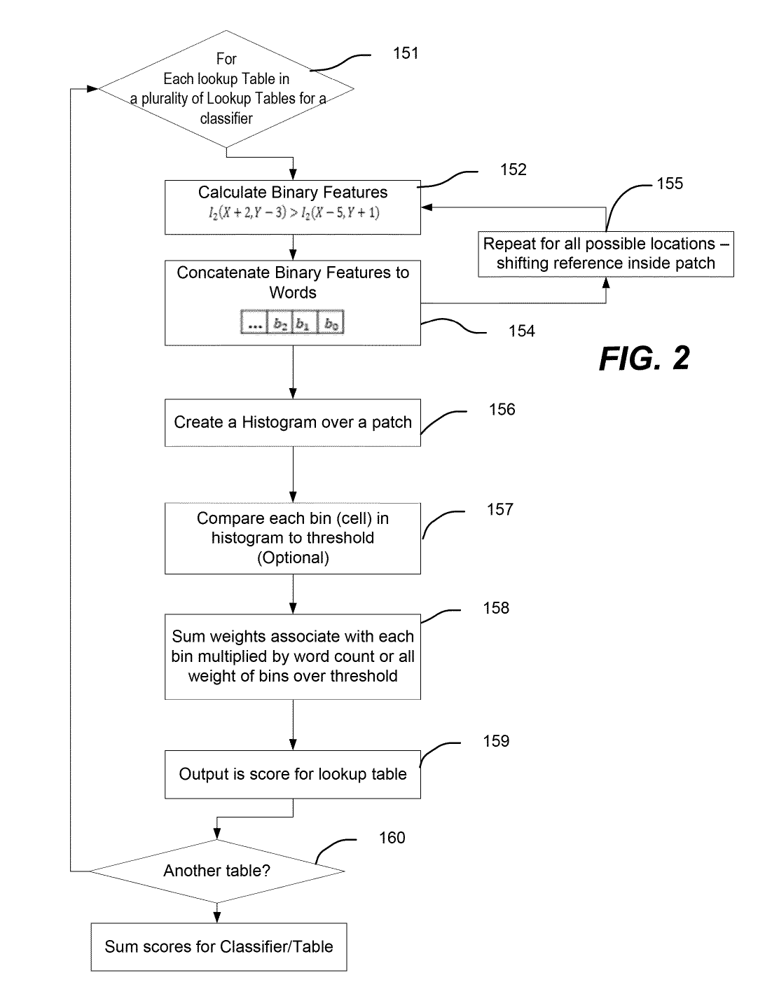

In a first classifier example, a classifier with a single lookup table is described. FIG. 2 illustrates an overall classification method in accordance with the technology. The value of pixel at position (x, y) of input channel k is denoted by Iₖ(x, y). In the below description, input channel 1 (a first input channel) may refer to IR and input channel 2 (a second input channel) may refer to depth data.

At step 152, the method calculates multiple binary features, where each feature is a simple comparison between two pixels, returning one or zero, depending on which of the pair of pixels is larger. The input pixels to each feature is defined as offsets from reference point. For example, a feature:

I₂(X+2, Y−3)>I₂(X−5, Y+1)

is one for reference point (x, y)=(20, 30) if value of pixel (22, 27) is larger than value of pixel (15, 31) [for channel 2].

At step 154, the method concatenates the set of binary features into a word. For example, each word is composed of 14 bits, where each bit is a single binary feature. The output word in this example is a number between 0 to (2¹⁴−1).

At 155, the method repeats steps 152 and 154 after shifting the reference point (x, y) to all possible locations inside some patch.

At 156, a histogram is built by counting the number of times each word value appears in the patch. At 157, an optional thresholding step is performed by comparing each bin (or cell) in the histogram to a predefined threshold.

At 158, a score for a specific lookup table per pose class is built by summing the weights associated with every bin in the table belonging to the pose class multiplied by the word count in it, or (if optional threshold step 157 is used) summing all weights of bins that crossed the threshold. At 159, an output of the score for a specific lookup table is provided.

The winning score among pose class scores for a given table identifies the gesture or pose in the input sample data image in sample date 132.

For a classifier with multiple lookup tables at 151, the above steps are repeated for each lookup table. If another table is present at 160, the method steps repeat until each lookup table is completed, and the scores summed per pose class at 161. (Each lookup has different input bits to build the word, and different weights for the histogram bins).

In another example, the classification method may be described with precise notation, without the optional threshold step 157, and using a single channel image for simplicity. The ferns ensemble classifier 130 operates on an image patch in the sample data 132, denoted by I, consisting of P pixels. For a pixel p, its neighborhood is denoted by N(p), and I_{N(p)} denotes the subpatch which is comprised of the pixels in p's neighborhood. I_{N(p)} is considered as a vector in [symbol] ^{|N(p)|}. The ferns ensemble consists of M individual ferns, and its pipeline includes three layers whose structure described below.

Bit vector computation, step 152 above, is performed as follows. Given one particular fern m: for each pixel p, a local descriptor of its neighborhood subpatch I_{N(p)} is computed using computationally-light pairwise pixel comparisons of the form:

I_{q1}>I_{q2} for q₁, q₂ ∈N(p) (1)

Such a comparison provides a single bit value of 0 or 1. For convenience of notation, one may rewrite the bit obtained as σ(β^{T}I_{N(p)}), where β is a |N(p)|-dimensional sparse vector, with two non-zero values, one equaling 1, the other equaling −1; and σ is the Heaviside function. For each fern m and pixel p, there are K bits computed, and the k^{th} bit is denoted as b^{m}_{p, k}=σ((β^{m}ₖ)^{T}I_{N(p)}). Collecting all the bits together, the K-dimensional bit vector b^{m}ₚ is:

b^{m}ₚ=σ(B^{m}I_{N(p)})∈ {0, 1}^{K} (2)

where the matrix B^{m} has rows (β^{m}₁)^{T}, . . . , (β^{m}_{K})^{T} Next, the the Heaviside function σ is applied element-wise.

Creation of a histogram of bit vectors, step 156 above, is performed as follows. In order to achieve some translation invariance, a spatial histogram over codewords is taken. However, the bit-vectors themselves are the codewords, as such an intermediate clustering step need not be utilized. Initially, the histogram for the m^{th} fern is denoted by H^{m}(b), where bit vector b ∈ {0, 1}^{K}; then:

$${H}^{m} ( b ) = {\sum }_{p ∈ {A}^{m}} δ ( {b}_{p}^{m} - b ) \qquad ( 3 )$$

where δ is a discrete delta function, and A^{m} ⊂ {1, . . . , P} is the spatial aggregation region for fern m. Note that H^{m} is a sparse vector, with at most P non-zero entries.

Histogram concatenation, step 154 above, is performed as follows. The final decision is made by a linear classifier applied to the concatenation of the M fern histograms:

$$f ( I ) = {W}^{T} H ( I ) = {\sum }_{m = \text{?}}^{M} {\sum }_{b ∈ \{ 0 , 1 \} \text{?}} {w}_{b}^{m} {H}^{m} ( b ) \\ \text{?} \text{indicates text missing or illegible when filed} \qquad ( 4 )$$

where H(I)=[H¹(I), . . . , H^{M}(I)] ∈ [symbol] ^{M2K} and W=[W¹, . . . , W^{M}] ∈ [symbol] ^{M2K} is a weight vector.

Combining Steps 152, 154 and 156 in the pipeline provides the Discriminative Ferns Ensemble classifier:

$$f ( I ; \text{?} ) = {\sum }_{m = \text{?}}^{M} {\sum }_{b ∈ \{ 0 , 1 \} \text{?}} {w}_{b}^{m} {\sum }_{p ∈ \text{?}} δ ( σ ( {B}^{m} {I}_{\text{?} ( p )} ) - b ) \\ \text{?} \text{indicates text missing or illegible when filed} \qquad ( 5 )$$

with the parameters ρ={W^{m}, B^{m}, A^{m}}^{M}ₘ₌₁.

The following Algorithm 1 summarizes the classification algorithm:

Algorithm 1 Ferns Ensemble: Classification

```
Input: An image I of size Sₓ × S_{y},
classifier parameters (B^{m},A^{m},W^{m})ₘ₌₁^{M}, threshold t
B^{m} ∈ [symbol]   ^{K×[A}^{m}], A^{m} ⊂ {1,..,Sₓ} × {1,..,S_{y}}, W^{m} ∈ [symbol]   ²^{^{K}}
Output: A classifier decision in {0, 1}
Initialization: Score=0
For all ferns m = 1,..,M
    For all pixels p ∈ A^{m}
        Compute a k-bit index = σ(B^{m}I_{N(p)})
        Score=score+W^{m}[index]
Return (Score>t)
```

The above Algorithm 1 describes the operation of a DFE during an analysis of an image of sample data 132. For each fern and each pixel in the fern's aggregation region, the bit vector is computed and considered as a codeword index. The fern table is then accessed with the computed index, and the obtained weight is added to the classification score. The complexity is O(MĀK) where Ā is the average number of pixels per aggregation region: Ā1/M Σₘ|A^{m}|.

The classifier architecture is designed to optimize both classification speed and accuracy when a large training set is available. Speed is obtained using simple binary features and direct indexing into a set of tables, and accuracy by using a large capacity model and careful discriminative optimization. The proposed framework is applied to the problem of hand pose recognition in depth and infra-red images, using a very large training set. Both the accuracy and the classification time obtained are considerably superior to relevant competing methods, allowing one to reach accuracy targets with run times orders of magnitude faster than the competition. Using DFE, one can significantly reduce classification time by increasing training sample size for a fixed target accuracy.

### Training/Learning

Training or learning 120 is illustrated in FIG. 1 and is described below. The learning phase uses a large training set. The training includes two parts: (1) at 122, selecting the offsets and channels for each bit/feature as well as the spatial aggregation region (where, in the above example, for the first bit channel 2, and offsets (+2, −3) (−5, +1), were selected); and (2) at 124, assigning weight to each entry of each lookup table (to associate with a cell of the histogram, as described above). More precisely, the training phase solves for the variables in the DFE classifier, described above. Unlike prior work on ferns, a discriminative rather than generative formulation is used. The variables are chosen in a discriminative manner. That is, the variables in part (1) are chosen so as to help the variables that are later chosen in part (2) to reach the best classification accuracy. Two learning strategies that solve parts (1) and (2) are presented and detailed in the following sections. The first strategy is based on info-gain and boosted Naïve Bayes. The second strategy, is based on the predictive features selection (PFS) algorithm for part (1) and SVM for part (2).

A sequence of lookup tables is used. As described above, every image may have multiple channels and may be mapped to a binary vector (step 156 above). This mapping is denoted by X(I)=(x₁, . . . , xₙ). (If each word is composed of 14 bits then n=2¹⁴). This mapping is defined by the following parameters: (1) Pixel comparison binary features: two (2) offsets and source channel for each feature (step 154 above); (2) A set of reference points that binary features are evaluated at (step 156 above); and (3) an optional threshold for every histogram bin (step 157 above). Thresholds are integers belonging to a finite group, for example 1, 2, 3 or 4.

Every hand image in the training set is also associated with a label y taking two possible values. For example, y=0 for closed hand and y=1 for open hand.

Boosted Naïve Bayes with info-gain training strategy: The goal of this training is to choose the parameters determining the mapping X(I) so as to maximize the info-gain criterion, defined as the following sum of mutual information:

maximize IG(X, y)=ΣI(xᵢ; y)

Where I(x;y) denotes the mutual information between x and y.

Next, maximizing the objective is done using greedy randomized approach: (A) randomize reference points by selecting at random a patch out of a predefined group of patches within the image (e.g. whole image, top-left quarter etc.), and setting reference points to be all locations in the selected patch, or a subset of them; (B) perform a pixel comparison of binary features which is initialized by setting all binary features to return 0 constantly; and (C) repeat, for every binary feature fᵢ:

(c1) Randomize a set of candidate features. For example: Every candidate consists of 2 offsets where each coordinate is selected at random between −10 and 10, and a random source channel index—IR\Depth\RGB image.

(c2) For every candidate: set current binary feature fᵢ to candidate. Then, consider all possible combinations of thresholds for histogram bins and evaluate the corresponding X mappings for all images in the training set. Compute IG(X; y) for the best X.

(c3) Set current binary feature fᵢ to the candidate that achieved maximal information-gain IG(X; y).

In one alternative, step C3 may be repeated to improve the objective further.

This optimizes for the mapping X, and now weights are assigned to each entry of the lookup table (used in step 158 above). Using a fresh training set (or by splitting the training set initially) train an SVM linear classifier with X(I) as input features and set the weights to the resulting model.

Multiple tables are learned in a boosted manner. The procedure above is repeated for every lookup table but this time every image in the training set is associated with a weight which is accounted for when computing IG(X; y) in C2 above and when training SVM.

To set the weights, the training set is classified as described in algorithm #1 using all lookup tables previously learned. Weights are assigned based on margin. The higher the margin, the higher the weight. For example, one can assign weight 0 (i.e. exclude from training of next fern) to all instances which are not support vectors (margin>1), and weight 1 to all support vectors.

In the procedure above, every image was assumed to have a binary label associated with it. It is possible to extend the algorithm to support multiclass labels by reducing to several binary 1-vs-all problems. (open vs. non-open, closed vs. non-closed etc.)

Learning and classification consist of performing the procedure above simultaneously for each 1-vs-all problem, while sharing the mapping X. The objective in the learning part is then the average info-gain, that is:

maximize IG(X; y₁)+IG(X; y₂)+IG(X; y₃)+ . . .

### PFS and SVM Training Strategy

In another alternative learning embodiment (steps 126, 128), given the DFE classifier f(I; ρ) in Equation (5), one can solve for the parameters ρ={W^{m}, B^{m}, A^{m}}^{M}ₘ₌₁ from a labeled training set {(Iⁱ, yⁱ)}^{N}ᵢ₌₁. Unlike prior work on ferns, a discriminative rather than a generative formulation is used.

Specifically, the problem is posed as regularized Hinge-loss minimization, similar to standard SVM:

$$\text{?} \frac{1}{2} \text{?} \text{?} {\text{?}}^{2} + \text{?} {\sum }_{i = 1}^{\text{?}} [ \text{?} - \text{?} f ( \text{?} \text{?} ) ] \text{?} \\ \text{?} \text{indicates text missing or illegible when filed} \qquad ( 6 )$$

where [·]₊ indicates the hinge loss, i.e. [z]₊=max{z, 0}. Rewriting Equation (4) above with explicit parameter and image dependence obtains:

$$\text{?} ( \text{?} ; \text{?} ) = \text{?} = \text{?} \text{?} ( \text{?} , \text{?} ; \text{?} , \text{?} ) \\ \text{?} \text{indicates text missing or illegible when filed} \qquad ( 7 )$$

If f is linear in W, so optimizing equation (6) with respect to W for fixed {B^{m}, A^{m}}^{M}ₘ₌₁ is a standard SVM optimization. However, optimizing for the latter parameters is challenging, specifically since they are to be chosen from a large discrete set of possibilities. Hence, an agglomerative approach is used in which ferns are greedily added, one at the time. As can be seen from Equation (5↑), adding a single fern amounts to an addition of 2^{K} new features to the classifier. In order to do that in a sensible manner, known results are extended for the case of a single feature addition.

Let f(I)=Σ^{L-1}ₗ=1wlxl(I) be a linear classifier optimized with SVM and L(f, {Iᵢ, yᵢ}^{N}ᵢ₌₁) the hinge loss obtained for it (Eq. (6)) over a training set. Assume one adds a single feature x^{L} to this classifier f^{new}(I)=f^{old}(I)+w_{L}x^{L}(I), with small |w_{L}|≦∈. Theorem 1 in the work of A. Bar-Hillel, D. Levi, E. Krupka, and C. Goldberg. Part-based feature synthesis for human detection. (In ECCV, 2010. 1, 3.3, 3.3, 3.3) gives a linear approximation of the loss under these conditions:

$$L ( \text{?} ) = L ( \text{?} ) - \text{?} \text{?} \text{?} \text{?} + \text{?} ( \text{?} ) \\ \text{?} \text{indicates text missing or illegible when filed} \qquad ( 8 )$$

where αᵢ are the example weights obtained as a solution to the dual SVM problem. The weights αᵢ ∈ [0, C] are only non-zero for support vectors. For a candidate feature x_{L}, the approximated loss is best reduced by choosing w_{L}=∈·sign(Σ^{N}ᵢ₌₁aᵢyᵢx^{L}ᵢ), and the reduction obtained is R(x_{L}) [symbol] Σ^{N}ᵢ₌₁αᵢyᵢx^{L}ᵢ|. The PFS algorithm (Bar-Hillel, et al., supra)] is based on training SVM using a small number of features, followed by computing the score R(x) for a large number of unseen features; this allows one to add/replace existing features with promising feature candidates. Note that the score R(x) of a feature column x can be seen as the correlation R_{z}(x)=x·Z, where Z=(z₁, . . . , zₙ) with zᵢ=yᵢaᵢ is the vector of signed example weights.

The aforementioned idea is extended to a set of features, as introduced by a single fern. Assuming one has trained an SVM classifier over a fern ensemble f^{M-1}(I) with M−1 ferns, and extension to an additional fern is desired. Assume further that the new weight vector is small with with |w^{m}∥_{∞}≦∈. Then, one has:

$$\text{?} ( I ) = \text{?} ( I ) + \text{?} \text{?} \text{?} \text{?} ( b , \text{?} ) \\ \text{?} \text{indicates text missing or illegible when filed} \qquad ( 9 )$$

with |w^{m}_{b}|≦1 for all b. Treating the new fern contribution as a single feature, one can apply the theorem stated above and get:

$$\text{?} \\ \text{?} \text{indicates text missing or illegible when filed} \qquad ( 10 )$$

where the approximation in the first equation is due to omission of O(∈²) terms. To minimize the approximated loss, the optimal choice for w^{m}_{b} is w^{m}_{b}=sign(Σ^{N}ᵢ₌₁aᵢyᵢH^{m}ₜ(b, Iᵢ)), in an analogous way to the single feature case. With these w^{m}_{b}, one obtains:

$$L ( \text{?} ( \text{?} ) ) = \text{?} \text{?} \text{?} - \text{?} \text{?} \text{?} ( \text{?} ( \text{?} ) ) \\ \text{?} \text{indicates text missing or illegible when filed} \qquad ( 11 )$$

Hence, the algorithm for fern ensemble grows based on iterating between SVM training and building the next fern based on Equation (11). This procedure is described in Algorithm 2:

Algorithm 2 Ferns Ensemble: Training

```
Input: A labeled Training set {Iᵢ,yᵢ}ᵢ₌₁^{N}
        Parameters M,K,C,N_{c},{A^{m}}ₘ₌₁^{M}
Output: A classifier (B^{m},A^{m},W^{m})ₘ₌₁^{M}, threshold t
Initialization: Z[i] = 1/[{Iᵢ|yᵢ = 1}] if yᵢ = 1,
            Z[i] = −1/[{Iᵢ|yᵢ = −1}] if yᵢ = −1
For m = 1,..,M
    For k = 1,..,K
        For c = 1,..N_{c}
          Sample a candidate column β_{k,c}^{m} ε R^{[N(p)]}
          For i = 1,..,N
            Compute H^{m}(b,Iᵢ,c) = H^{m}(b,Iᵢ;B_{c}^{m})
            with B_{c}^{m} = [β₁^{m},..,βₖ₋₁^{m},β_{k,c}^{m}]
          For b ε {0, 1}^{K}
            Compute R_{Z}(c) = Σ_{bε{0,1}}^{K} R_{Z}(H^{m}(b;β_{k,c}^{m}))
        Choose winning candidate c* = argmax_{c}R(c),
        and set βₖ^{m} = β_{k,c*}^{m}
    Train an SVM with m2^{K} features W · [H¹,..,H^{m}] − t
    Set Z[i] = yᵢαᵢ for i = 1,..,N with αᵢ SVM dual variables
Set {W^{m}}ₘ₌₁^{M},t based on the last SVM training.
Return (B^{m},A^{m},W^{m})ₘ₌₁^{M}, threshold t.
```

At each fern addition step, an SVM classifier trained on the previous ferns is used to get signed example weights, in a manner similar to boosting. The ensemble score ρ_{b ∈ {0, 1}}^{K}R_{Z}(H^{m}(b)) is used to grow the fern bit-by-bit in a greedy fashion. At each bit addition stage, N_{c} candidates are randomly selected for the mask β^{m}ₖ, termed β^{m}_{k, c}; each candidate is chosen by randomly drawing the two pixels needed for the comparison. The winning bit is chosen as the one producing the highest ensemble score. In one embodiment, the integration area variables {Aₘ}^{M}ₘ₌₁, are not optimized, however several optimization choices are presented below. The algorithm is presented for a single binary problem, but is easily extended to training of several classes with shared A^{m}, B^{m} and separate W^{m}. During optimization, multiple SVMs are trained at each fern addition, and R(c) scores of all of them are summed to make the bit choice.

### Classification Speed

In comparing the CPU time of a single fern to a single tree with the depth K, from a pure computational complexity perspective, the number of operations for both is K. Nevertheless, reveals large differences in expected run time between these techniques exists. First, a tree needs to store the bit computation parameters for 2^{K} internal nodes. More importantly, during tree traversal, the working set is accessed K times in an unpredictable manner. A fern's operation requires only a single access to its large working set (W^{m}) as the index computation is done using a small amount of memory, O(K) in size, which fits in the cache without a problem.

Second, the usage of fixed pixel pairs in a fern enables computation of the K-bit index without indirection and with an unrolled loop. More importantly, ferns are amenable to vectorization using Single Instruction, Multiple Data (SIMD) operations, while trees are not. Applying a fern operation to several examples at the same time (i.e. vectorizing the loop over p in Algorithm 1) is straightforward. Doing so for a tree is likely to be extremely inefficient since each example require a different sequence of memory accesses, and gathering such scattered data cannot be done in parallel in a SIMD framework.

Experimental results using the test data were developed, tested and compared to alternatives on a very large data set for hand shape recognition.

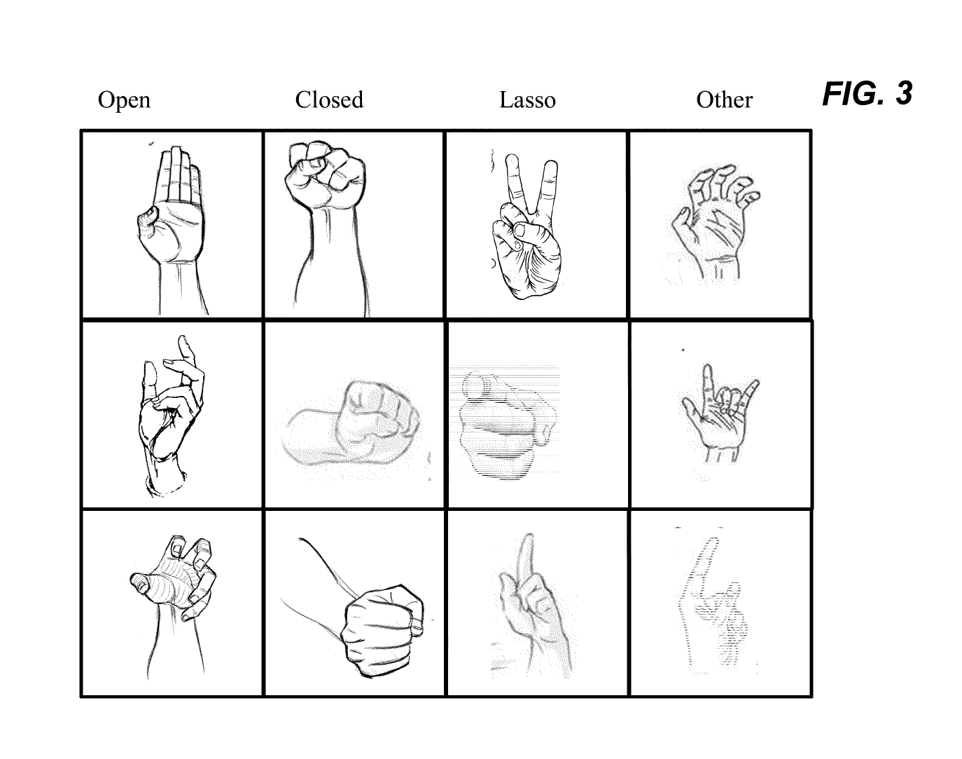

The task considered is to recognize three different hand shapes, and to discriminate between them and other undefined hand states. The recognition results are used as part of a NUI. The shapes are termed “Open”, “Closed,” “Lasso” and “Other,” as illustrated in FIG. 3. The class ‘Other’ includes a large variation in hand poses, including hands holding objects. Hand detection is achieved by tracking the skeleton in a sequence of depth+IR images.

The images used for recognition are cropped around the extracted hand position, rotated and scaled to two 36×36 images of the depth and IR channels. A simple pre-processing rejects IR and depth pixels where the depth is clearly far beyond the hand, thereby removing some of the background. The alignment and rotation of the hand is based on estimated wrist position and is sometimes inaccurate, making the recognition task harder.

A dataset of 519,000 images was collected and labeled from video sequences of different people. Images have considerable variability in terms of viewpoints, hand poses, distances and imaging conditions. The images were taken at distances of up to ˜4 meters from the camera, where the quality of image drops, and the depth measurement of fingers may be missing. Data was divided into training and test sets with 420,000 and 99,000 images respectively, such that persons from the training set do not appear in test images and vice versa. The data was collected to give over-representation to hard cases. Given the properties of data, the goal was to achieve 2-5% false negative rate, at a false positive rate of 2%. Since the test data is hard, the error rate in real usage scenarios is expected to be much lower.

The number of bits per fern K, and the number of ferns Al in were tested. At each bit addition step N_{c}=40 pixel comparison features were randomly generated for evaluation. The spatial aggregation area of the fern Aₘ was randomly chosen to be one of the 4 standard quadrants of the image patch, and the neighborhood AV) is 17×17 pixels. In an additional embodiment, one may limit the aggregation area Aₘ further by imposing a virtual checkerboard on the quadrant pixels: for odd bit indices features are only computed for ‘white’ pixels, and for even indices features are computed only for ‘black’ ones. This policy was found to be useful in terms of accuracy-speed trade-offs.

In the experimental data, the LibLinear package (an open source library for large-scale linear classification) for sparse SVM training of models. The classifier was implemented in C and running times are reported on Intel core i7, 2.6 GHz CPU, using a single thread. Computation time is reported for a single image in milliseconds, without usage of SIMD optimizations. Accuracy of a single binary classifier, i.e. one hand pose versus all, is computed as the false negative error rate at the working point providing a false positive (FP) rate of 2%. Accuracy figures reported here are averaged over the three classes.

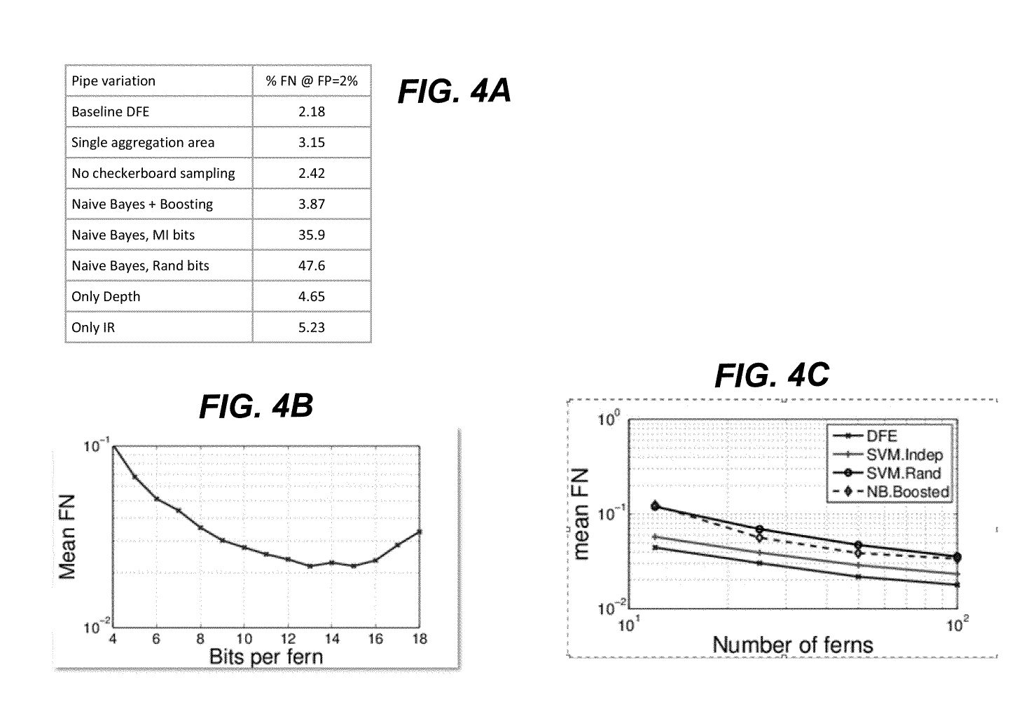

FIGS. 4A-4C illustrates the contribution to performance of various algorithm components.

Complexity of layers 1: At the first layer (step 152 above), patches are encoded into codeword indices, and its complexity is controlled by the number of bits K used for the encoding. In FIG. 4B the classifier accuracy is plotted as a function of K for fixed M=50. Based on this graph, the value of K=13 was selected in subsequent experiments, as it is the minimal value which yet provide close to optimal accuracy.

Complexity of layers 2: At the second, spatial aggregation layer, complexity is controlled by several algorithmic choices. First, multiple aggregation areas, or a single aggregation area containing the whole image for all ferns can be used. Second, the checkerboard technique for computational saving can be optionally used or not used. Results are reported in FIG. 4A. Baseline DFE uses M=50 ferns with quadrant ferns, checkerboard policy. The number of ferns used in the conditions ‘single area’ and ‘no checkerboard’ are reduced by a factor 4 and 2 to get classifiers with approximately the same speed as the baseline. The results show the advantage of baseline DFE over alternatives, hence led to its definition as ‘baseline’.

Complexity of layer 3, optimization policy: FIG. 4A shows the accuracy for several ensemble training strategies. The simpler alternatives uses Naive Bayes, where the leaf weights are based on class posterior probabilities. The ferns are trained independently, with bits chosen at random (Naive Bayes, Rand bits) or by maximization of information gain (Naive Bayes, MI). For these alternatives, the false negative rate is high. Note that FN is measured at false positive rate of 2%. Hence, FN near 50% is far better than random. At FP=10% the false negative rates of Naïve Bayes MI bits and Rand bits drops to 11% and 18% respectively. Also, further increasing of the number ferns does not help as much as in the DFE or boosting framework, as the ferns are learned independently. Another alternative is training complementary ferns by boosting, with bits chosen to maximize the information gain on the boosting-reweighted sample (Naive Bayes Boosting). This significantly improves accuracy relative to MI and random selection, but is still less accurate than DFE. FIG. 4C shows the effect of number of ferns, M, on the false negative rate for selected methods.

From the above results, it is noted that using discriminative (SVM) approach for both the final classifier and selecting of the fern bits, significantly improves accuracy.

The table in FIG. 4A also shows that IR and depth are not redundant, and using both of them significantly improves accuracy relative to using only one of them.

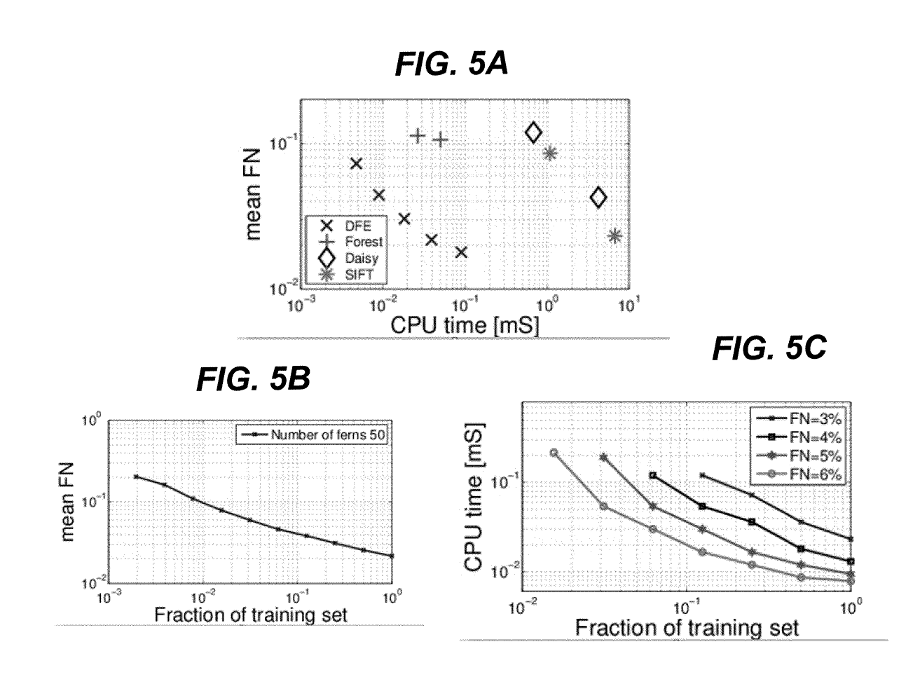

FIGS. 5A-5C show the results of a comparison of the fern ensemble method to several alternative architectures, in terms of a speed-accuracy trade-off. The methods compared are:
Random forest applied to pixel comparisons as suggested by R.-E. Fan, K.-W. Chang, C.-J. Hsieh, X.-R. Wang, and C.-J. Lin. Liblinear: A library for large linear classification. Journal of Machine Learning Research, 9:1871-1874, 2008.
A 3-stages pipeline: a) Fast dense SIFT features computation using the VLFeat library: A. Bar-Hillel, D. Levi, E. Krupka, and C. Goldberg. Part-based feature synthesis for human detection. In ECCV, 2010. b) Encoding into a bag of features using a random forest dictionary P. Doll'ar, S. Belongie, and P. Perona. The fastest pedestrian detector in the west. In BMVC, 2010, c) SVM classification with a linear approximation of the histogram intersection kernel, according to A. Bar-Hillel, D. Hanukaev, and D. Levi. Fusing visual and range imaging for object class recognition. In ICCV, 2011. The same pipeline was also tried with replacing the fast SIFT with dense Daisy features as in J. Shotton, T. Sharp, A. Kipman, A. W. Fitzgibbon, M. Finocchio, A. Blake, M. Cook, and R. Moore. Real-time human pose recognition in parts from single depth images. Commun. ACM, 56(1)116-124, 2013.

All the methods were implemented in C/C++, using the original author's code when possible. They were chosen for comparison as each of them was developed with the aim of obtaining a good balance of speed and accuracy. Multiple working points were tested for each of these methods, representing various optimization for speed and accuracy. For the fast SIFT method, shifting between speed and accuracy was done by changing the stride parameter, controlling the density of the SIFT greed. The Daisy complexity was chosen to optimize speed/accuracy, as recommended in Shotten et al, above.

The (CPU time, accuracy) of the best working points obtained by each of the algorithms, including DFE, are plotted together in FIG. 4 A. A random forest can achieve similar classification time to that of DFE, but is significantly less accurate (FN=10.6% vs. FN=2% for DFE, for the same CPU budget). The best accuracy is achieved by training on a small number of deep trees, with little improvement when increasing the number of trees. There are several reasons why using 50 ferns DFE is about as fast as using two trees. First, each fern operates on relatively small number of pixels (50), which is only ˜4% of the image. Second, calculating the ferns bits requires less operations than forest with the same depth. Third, the number of bit per fern is 13, while the depth of tree is 21. Also, the memory size of the forest is in order of 80 MB vs. 2.5 MB of ferns. Since 80 MB cannot fit into a standard cache, more cache misses may result.

The accuracy of with fast SIFT and Daisy alternatives, can approach the accuracy of the DFE. However, their classification time is two order of magnitudes longer.

In addition to high accuracy and fast classification, DFE approach enable significant flexibility for various trade-offs of speed, accuracy, memory size and generalization from various sizes of training set. As discussed before, the fern ensemble architecture trades speed and accuracy for sample size and memory. For each training set size, given constraints on memory and classification time, accuracy is optimized by tuning M and K. Increasing the training set size enables not only improved accuracy, but also to significantly reductions the classification time.

FIG. 5B shows the effect of increasing the training set size on FN, for fixed M and K. The training set size is modified from ˜0.2% of the full set (820 images) to the full training set (420,000 images). The subset of training set is selected randomly. As expected, the false negative rate reduces with increase of training set size.

Even with a training set size of ˜30,000 samples (0.07 in x-axis of FIG. 5B) the accuracy met minimum requirements for the product. However, even after full code optimization, the classification time significantly exceeded the target budget.

FIG. 5C shows the classification time as a function of the of training set size, relative to the full set, for various target false negative rates. For a fixed target accuracy, the classification time can be reduced by an order of magnitude, if the training set size is increased by an order of magnitude. In general, as training set size increases, K is slightly increased and significantly reduces M to achieve same target accuracy with lower classification time. This can be explained by the effect of K on the capacity of each fern, and hence should be adapted to the training set size. On the other hand, the accuracy can be improved by increasing M, but at a significant cost of classification time.

Finally, the tradeoff between memory and accuracy is shown below. Table 1 (below) presents false negative rate versus memory consumption for a fern ensemble. Memory consumption can be reduced by lowering either M or K, and in the table optimal M, K parameters are chosen for each memory limit point. From table 1, it is noted that adding a memory constraint leads to significant reduction in the number of bits per fern, and increasing the number of ferns. The result is very different from the case of optimizing for classification time, where optimal number of bits is high. This is not surprising, as the memory size increases exponentially with number of bits, but classification time increases only linearly. The result classification time is about 5-10 larger when optimizing for memory instead of for speed. Note, however, that in a baseline implementation, with 50 ferns and 13 bits the memory size is about 2.5 MB, which still fits into the cache.

TABLE 1

| LUT entries | Ferns # (M) | Bits # (K) | % FN @ FP = 2% |
|---|---|---|---|
| 768 | 48 | 4 | 10.7 |
| 1536 | 96 | 4 | 7.78 |
| 3072 | 96 | 5 | 6.07 |
| 6144 | 192 | 5 | 5.42 |
| 12288 | 384 | 5 | 4.21 |
| 24576 | 384 | 6 | 2.97 |
| 49152 | 768 | 6 | 2.32 |

Table 1 illustrates the accuracy obtained by DFE under memory limits. LUT entries is the total number of entries in all the lookup tables (ferns) together, which is 2^{K}M. In one implementation, each LUT entry requires 6 bytes—two bytes per class, representing the SVM weights.

The discriminative fern ensemble framework enables significantly pushing of the accuracy-speed envelope for visual recognition in IR+depth images. Thin, efficient architecture, and discriminative optimization were found important for this purpose. In terms of architecture, the table-based approach to deeper models with more table layers.

FIG. 6 illustrates one embodiment of a capture device 20 and computing environment 12 that may be used in the target recognition, analysis and tracking system 10 to recognize human and non-human targets in a capture environment 100 (without special sensing devices attached to the subjects), uniquely identify them and track them in three dimensional space. According to one embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z-axis extending from the depth camera along its line of sight.

As shown in FIG. 6, the capture device 20 may include an image camera component 32. According to one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

As shown in FIG. 6, the image camera component 32 may include an IR light source 34, a three-dimensional (3-D) camera 36, and an RGB or IR camera 38, that may be used to capture the respective first and second channels including a depth image of a capture area. For example, in time-of-flight analysis, the IR light source 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

According to one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light source 34. Upon striking the surface of one or more targets or objects in the capture area, the pattern may become deformed in response. Such a deformation of the pattern may be captured by, for example, the 3-D camera 36 and/or the RGB camera 38 and may then be analyzed to determine a physical distance from the capture device to a particular location on the targets or objects.

According to one embodiment, the capture device 20 may include two or more physically separated cameras that may view a capture area from different angles, to obtain visual stereo data that may be resolved to generate depth information. Other types of depth image sensors can also be used to create a depth image.

The capture device 20 may further include a microphone 40. The microphone 40 may include a transducer or sensor that may receive and convert sound into an electrical signal. According to one embodiment, the microphone 40 may be used to reduce feedback between the capture device 20 and the computing environment 12 in the target recognition, analysis and tracking system 10. Additionally, the microphone 40 may be used to receive audio signals that may also be provided by the user to control applications such as game applications, non-game applications, or the like that may be executed by the computing environment 12.

In one embodiment the microphone 40 comprises array of microphone with multiple elements, for example four elements. The multiple elements of the microphone can be used in conjunction with beam forming techniques to achieve spatial selectivity In one embodiment, the capture device 20 may further include a processor 42 that may be in operative communication with the image camera component 32. The processor 42 may include a standardized processor, a specialized processor, a microprocessor, or the like that may execute instructions that may include instructions for storing profiles, receiving the depth image, determining whether a suitable target may be included in the depth image, converting the suitable target into a skeletal representation or model of the target, or any other suitable instruction.

Processor 42 may include an imaging signal processor capable of adjusting color, brightness, hue, sharpening, and other elements of the captured digital image.

The capture device 20 may further include a memory component 44 that may store the instructions that may be executed by the processor 42, images or frames of images captured by the 3-D camera or RGB camera, user profiles or any other suitable information, images, or the like. According to one example, the memory component 44 may include random access memory (RAM), read only memory (ROM), cache, Flash memory, a hard disk, or any other suitable storage component. As shown in FIG. 6, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 6 are housed in a single housing.

The capture device 20 may be in communication with the computing environment 12 via a communication link 46. The communication link 46 may be a wired connection including, for example, a USB connection, a Firewire connection, an Ethernet cable connection, or the like and/or a wireless connection such as a wireless 802.11 b, g, a, or n connection. The computing environment 12 may provide a clock to the capture device 20 that may be used to determine when to capture, for example, a scene via the communication link 46.

The capture device 20 may provide the depth information and images captured by, for example, the 3-D camera 36 and/or the RGB camera 38, including a skeletal model that may be generated by the capture device 20, to the computing environment 12 via the communication link 46. The computing environment 12 may then use the skeletal model, depth information, and captured images to, for example, create a virtual screen, adapt the user interface and control an application such as a game or word processor.

A motion tracking system 191 uses the skeletal model and the depth information to provide a control output to an application on a processing device to which the capture device 20 is coupled. The depth information may likewise be used by a gestures library 192, structure data 198, gesture recognition engine 190, depth image processing and object reporting module 194 and operating system 196. Depth image processing and object reporting module 194 uses the depth images to track motion of objects, such as the user and other objects. The depth image processing and object reporting module 194 may report to operating system 196 an identification of each object detected and the location of the object for each frame. Operating system 196 will use that information to update the position or movement of the user relative to objects or application in the display or to perform an action on the provided user-interface. To assist in the tracking of the objects, depth image processing and object reporting module 194 uses gestures library 192, structure data 198 and gesture recognition engine 190.

The computing environment 12 may include one or more applications 300 which utilize the information collected by the capture device for use by user 18. Structure data 198 includes structural information and skeletal data for users and objects that may be tracked. For example, a skeletal model of a human may be stored to help understand movements of the user and recognize body parts. Structural information about inanimate objects may also be stored to help recognize those objects and help understand movement.

Gestures library 192 may include a collection of gesture filters, each comprising information concerning a gesture that may be performed by the skeletal model (as the user moves). A gesture recognition engine 190 may compare the data captured by the cameras 36, 38 and device 20 in the form of the skeletal model and movements associated with it to the gesture filters in the gesture library 192 to identify when a user (as represented by the skeletal model) has performed one or more gestures. Those gestures may be associated with various controls of an application. Thus, the computing environment 12 may use the gestures library 192 to interpret movements of the skeletal model and to control operating system 196 or an application (not shown) based on the movements.

A dynamic display engine 302 interacts with applications 300 to provide an output to, for example, display 16 in accordance with the technology herein. The dynamic display engine 302 utilizes interaction state definitions 392 and layout display data 394 to determine dynamic display states on the output display device in accordance with the teachings herein.

In general, the dynamic display engine 302 determines a user interaction state based on a number of data factors as outlined herein, then uses the state to determine an application layout state for information provided on the display. Transitions between different interaction states, or movements from an application state are also handled by the dynamic display engine. The application layout state may include an optimal layout state—the developer's desired display when a user is in a “best” interaction state as defined by the developer—as well as numerous other application layout states based on specific interaction states or based on changes (or movements) by a user relative to previous states of the user.

FIG. 7 is a block diagram of one embodiment of a computing system that can be used to implement a hub computing system like that of FIG. 6 at 12. In this embodiment, the computing system is a multimedia system 800, such as a gaming console. As shown in FIG. 7, the multimedia system 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 806. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is configured as a flash ROM that is connected to memory controller 802 via a PCI bus and a ROM bus (neither of which are shown). RAM 806 is configured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an A/V (audio/video) port 828 for transmission to a television or other display. In the illustrated implementation, video and audio processing components 820-828 are mounted on module 214.

FIG. 7 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 7 system 800 includes a controller support subassembly 840 for supporting four controllers 804(1)-804(4). The controller support subassembly 840 includes any hardware and software components needed to support wired and wireless operation with an external control device, such as for example, a media and game controller. A front panel I/O subassembly 842 supports the multiple functionalities of power button 812a, the eject button 813, as well as any LEDs (light emitting diodes) or other indicators exposed on the outer surface of console 800. Subassemblies 840 and 842 are in communication with module 814 via one or more cable assemblies 844. In other implementations, system 800 can include additional controller subassemblies. The illustrated implementation also shows an optical I/O interface 835 that is configured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be configured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into system 800 or a controller, MU 840 can be accessed by memory controller 802. A system power supply module 850 provides power to the components of gaming system 800. A fan 852 cools the circuitry within system 800. A microcontroller unit 854 is also provided.

An application 860 comprising machine instructions is stored on hard disk drive 808. When system 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Gaming and media system 800 may be operated as a standalone system by simply connecting the system to a display 16, a television, a video projector, or other display device. In this standalone mode, gaming and media system 800 enables one or more players to play games, or enjoy digital media, e.g., by watching movies, or listening to music. However, with the integration of broadband connectivity made available through network interface 832, gaming and media system 800 may further be operated as a participant in a larger network gaming community.

The system described above can be used to add virtual images to a user's view such that the virtual images are mixed with real images that the user see. In one example, the virtual images are added in a manner such that they appear to be part of the original scene.

FIG. 8 illustrates another example embodiment of a computing system 1520 that may be the computing environment 12 shown in FIG. 6 used to track motion and/or animate (or otherwise update) an avatar or other on-screen object displayed by an application. The computing system environment 1520 is only one example of a suitable computing system and is not intended to suggest any limitation as to the scope of use or functionality of the presently disclosed subject matter. Neither should the computing system 1520 be interpreted as having any dependency or requirement relating to any one or combination of components illustrated in the exemplary operating system 1520. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

Computing system 1520 comprises a computer 1541, which typically includes a variety of computer readable media. Computer readable media can be any available media that can be accessed by computer 1541 and includes both volatile and nonvolatile media, removable and non-removable media. The system memory 1522 includes computer storage media in the form of volatile and/or nonvolatile memory such as read only memory (ROM) 1523 and random access memory (RAM) 1560. A basic input/output system 1524 (BIOS), containing the basic routines that help to transfer information between elements within computer 1541, such as during start-up, is typically stored in ROM 1523. RAM 1560 typically contains data and/or program modules that are immediately accessible to and/or presently being operated on by processing unit 1559. By way of example, and not limitation, FIG. 8 illustrates operating system 1525, application programs 1526, other program modules 1527, and program data 1528.

The computer 1541 may also include other removable/non-removable, volatile/nonvolatile computer storage media. By way of example only, FIG. 8 illustrates a hard disk drive 1538 that reads from or writes to non-removable, nonvolatile magnetic media, a magnetic disk drive 1539 that reads from or writes to a removable, nonvolatile magnetic disk 1554, and an optical disk drive 1540 that reads from or writes to a removable, nonvolatile optical disk 1553 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1538 is typically connected to the system bus 1521 through an non-removable memory interface such as interface 1534, and magnetic disk drive 1539 and optical disk drive 1540 are typically connected to the system bus 1521 by a removable memory interface, such as interface 1535.

The drives and their associated computer storage media discussed above and illustrated in FIG. 8, provide storage of computer readable instructions, data structures, program modules and other data for the computer 1541. In FIG. 8, for example, hard disk drive 1538 is illustrated as storing operating system 1558, application programs 1557, other program modules 1556, and program data 1555. Note that these components can either be the same as or different from operating system 1525, application programs 1526, other program modules 1527, and program data 1528. Operating system 1558, application programs 1557, other program modules 1556, and program data 1555 are given different numbers here to illustrate that, at a minimum, they are different copies. A user may enter commands and information into the computer 1541 through input devices such as a keyboard 1551 and pointing device 1552, commonly referred to as a mouse, trackball or touch pad. Other input devices (not shown) may include a microphone, joystick, game pad, satellite dish, scanner, or the like. These and other input devices are often connected to the processing unit 1559 through a user input interface 1536 that is coupled to the system bus, but may be connected by other interface and bus structures, such as a parallel port, game port or a universal serial bus (USB). The cameras 226, 228 may define additional input devices for the computing system 1520 that connect via user input interface 1536. A monitor 1542 or other type of display device is also connected to the system bus 1521 via an interface, such as a video interface 1532. In addition to the monitor, computers may also include other peripheral output devices such as speakers 1544 and printer 1543, which may be connected through a output peripheral interface 1533.

The computer 1541 may operate in a networked environment using logical connections to one or more remote computers, such as a remote computer 1546. The remote computer 1546 may be a personal computer, a server, a router, a network PC, a peer device or other common network node, and typically includes many or all of the elements described above relative to the computer 1541, although only a memory storage device 1547 has been illustrated in FIG. 8. The logical connections depicted include a local area network (LAN) 1545 and a wide area network (WAN) 1549, but may also include other networks. Such networking environments are commonplace in offices, enterprise-wide computer networks, intranets and the Internet.

When used in a LAN networking environment, the computer 1541 is connected to the LAN 1545 through a network interface or adapter 1537. When used in a WAN networking environment, the computer 1541 typically includes a modem 1550 or other means for establishing communications over the WAN 1549, such as the Internet. The modem 1550, which may be internal or external, may be connected to the system bus 1521 via the user input interface 1536, or other appropriate mechanism. In a networked environment, program modules depicted relative to the computer 1541, or portions thereof, may be stored in the remote memory storage device. By way of example, and not limitation, FIG. 8 illustrates application programs 1548 as residing on memory device 1547. It will be appreciated that the network connections shown are exemplary and other means of establishing a communications link between the computers may be used.

### Exemplary Embodiments

In accordance with the description, the technology includes a gesture recognition system, comprising: a capture device receiving image data including at least depth data; and a processor operably coupled to the capture device including code operable to instruct the processor to classify a gesture of a human body in sample image data received by the capture device using a classifier based on a discriminative ferns ensemble.

Embodiments include a system as in any of the aforementioned embodiments wherein the classifier uses a learned model based on a first set of training data, the learned model comprises at least one optimized fern based on binary features calculated for the image data, the optimized fern being weighted based on comparison to a support vector machine classifier trained using a second set of training data.

Embodiments include a system as in any of the aforementioned embodiments wherein the classifier comprises code operable to instruct a processor to: select a patch in an image in the sample image data; calculate multiple binary features of the image in the sample image data; concatenate a set of binary features for the image into a word; repeat the calculate and concatenate steps after shifting a reference point for the calculate and concatenate steps to all possible points in the image; build a histogram comprising a count of a number of times each word appears in the image; and sum all weights of cells of the histogram thereby providing a score for the fern.

Embodiments include a system as in any of the aforementioned embodiments wherein the processor is operable to compare each cell of the histogram to a threshold and wherein the sum of all weights comprises all weights of all cells over the threshold.

Embodiments include a system as in any of the aforementioned embodiments wherein for the classifier includes multiple lookup ferns, calculation of multiple binary features and concatenation of the set of binary features is repeated for each lookup fern, and wherein a sum the weights of the multiple lookup ferns scores is provided.

Embodiments include a system as in any of the aforementioned embodiments wherein the sample image data may include multiple channels, a first channel comprising said depth data and a second channel comprising IR data, and wherein the learned model is provided by analysis of the first set of training data including a plurality of training images, the processor operable to: select an offsets and channels for each bit in each training image; and assign a weight to each entry of each lookup fern for the training image.

Embodiments include a system as in any of the aforementioned embodiments wherein, for a single lookup fern, the processor is operable to create a binary vector for each training image by: comparing binary features of each pixel in each training image of two offsets and the first or second channel for each feature; evaluating the binary features by shifting a set of reference points; and comparing the binary features to a threshold for every histogram bin.

Embodiments include a system as in any of the aforementioned embodiments wherein the learned model is adapted to maximize an information gain criterion, the learned model created by: randomizing reference points by selecting at random a patch from a group of patches within the first set of training data and setting reference points to at least a subset of locations within the patch selected; comparing binary features of pixels within the patch by setting all binary features to return 0 constantly; for every binary feature, randomizing a set of candidate binary features and for every candidate, setting a current binary feature to a candidate and consider possible combinations of thresholds for histogram bins and evaluate corresponding binary mappings for all images in the training set; calculate the maximum information gain for binary features mappings of each candidate; and set current binary feature to the candidate that achieved maximum information gain.

Embodiments include a system as in any of the aforementioned embodiments wherein a plurality of lookup ferns is provided and the randomizing reference points, comparing binary features and randomizing a set of candidate binary features is repeated for every lookup fern where every image in the first training set is associated with a weight which is accounted for when computing maximum information gain.

Embodiments include a system as in any of the aforementioned embodiments wherein a weight is assigned to each fern by using a second set of training data to train an SVM linear classifier with the binary features and assign weights to a resulting learned model.

Embodiments of the technology include a computer implemented method of classifying sample image data to determine a gesture present in the sample image data, the method comprising: creating a discriminative ferns ensemble classifier having direct indexing to a set of classification tables, the tables developed using a learned model based on a first set of training data and optimized by a weighting of the tables using an SVM linear classifier based on a second set of training data; receiving sample image data to be classified from a capture device, the capture device including a first input channel and a second input channel; analyzing the sample image data using the discriminative ferns ensemble classifier; and outputting a determination of the gesture in the sample image data, the determination enabling a manipulation of a natural user interface.

Embodiments include a method as in any of the aforementioned embodiments wherein the classifier performs a method of: calculating multiple binary features of an image in the sample image data; concatenating a set of binary features for the image into a word; repeating said calculating and said concatenating after shifting a reference point in the sample image data to all possible points in the sample image data; creating a histogram comprising a count of a number of times each word appears in the image; and summing all weights in cells of the histogram thereby providing a score for the fern.

Embodiments include a method as in any of the aforementioned embodiments wherein the sample image data may include multiple channels, a first channel comprising depth data and a second channel comprising IR data, and wherein the learned model is provided by analysis of the first set of training data including a plurality of training images, the method including steps: selecting a offsets and channels for each bit in each training image; and assigning a weight to each entry of each lookup fern for the training image.

Embodiments include a method as in any of the aforementioned embodiments wherein for a single lookup fern, the method creates a binary vector for each training image by: comparing binary features of each pixel in each training image of two offsets and the first or second channel for each feature; evaluating the binary features by shifting a set of reference points; and comparing the binary features to a threshold for every histogram bin.

Embodiments include a method as in any of the aforementioned embodiments wherein the learned model is further created to maximize an information gain criterion by: randomizing reference points by selecting at random a patch from a group of patches within the first set of training data and setting reference points to at least a subset of locations within the patch selected; comparing binary features of pixels within the patch by setting all binary features to return 0 constantly; for every binary feature, randomizing a set of candidate binary features and for every candidate, setting a current binary feature to a candidate and consider possible combinations of thresholds for histogram bins and evaluate corresponding binary mappings for all images in the training set; calculating a maximum information gain for binary features mappings of each candidate; and assigning the current binary feature to the candidate that achieved maximum information gain,

Additional embodiments include A pose detection and classification system adapted to classify human poses in sample image data, comprising: a capture device including a first input channel and a second input channel, each channel providing sample image data; a processing device operable on the sample image data using a discriminative ferns ensemble classifier having direct indexing to a set of classification tables, the tables developed using a first set of training data and optimized by a weighting of the tables using an SVM linear classifier configured based on a second set of training data, the processing device a outputting a determination of the pose in the sample image data, the determination enabling a manipulation of a natural user interface.

Embodiments include a pose detection and classification system as in any of the aforementioned embodiments wherein the ensemble classifier comprises code operable to instruct a processor to: select a patch in an image in the sample image data; calculate multiple binary features of the image in the sample image data; concatenate a set of binary features for the image into a word; repeat the calculate and concatenate steps after shifting a reference point for the calculate and concatenate steps to all possible points in the image; build a histogram comprising a count of a number of times each word appears in the image; and sum all weights of cells of the histogram thereby providing a score for the fern.

Embodiments include a pose detection and classification system as in any of the aforementioned embodiments further including wherein the processor is operable to compare each cell of the histogram to a threshold and wherein the sum of all weights comprises a sum of all weights of all cells over the threshold.

Embodiments include a pose detection and classification system as in any of the aforementioned embodiments wherein for the classifier includes multiple lookup ferns, calculation of multiple binary features and concatenation of the set of binary features is repeated for each lookup fern, and wherein a sum of weights of multiple lookup ferns scores is provided.

Embodiments include a pose detection and classification system as in any of the aforementioned embodiments wherein the classification tables are adapted to maximize an information gain criterion, the classification tables created by: randomizing reference points by selecting at random a patch from a group of patches within the first set of training data and setting reference points to at least a subset of locations within the patch selected; comparing binary features of pixels within the patch by setting all binary features to return 0 constantly; for every binary feature, randomizing a set of candidate binary features and for every candidate, setting a current binary feature to a candidate and consider possible combinations of thresholds for histogram bins and evaluate corresponding binary mappings for all images in the training set; calculate the maximum information gain for binary features mappings of each candidate; and set current binary feature to the candidate that achieved maximum information gain.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gesture recognition system, comprising:
a capture device receiving image data including at least depth data; and
a processor operably coupled to the capture device including code operable to instruct the processor to classify a gesture of a human body in sample image data received by the capture device using a classifier based on a discriminative ferns ensemble.

2. The system of claim 1 wherein the classifier uses a learned model based on a first set of training data, the learned model comprises at least one optimized fern based on binary features calculated for the image data, the optimized fern being weighted based on comparison to a support vector machine classifier trained using at least one of the first set of training data and a second set of training data.

3. The system of claim 1 wherein the classifier comprises code operable to instruct a processor to:
select a patch in an image in the sample image data;
calculate multiple binary features of the image in the sample image data;
concatenate a set of binary features for the image into a word;
repeat the calculate and concatenate steps after shifting a reference point for the calculate and concatenate steps to all possible points in the image patch;
build a histogram comprising a count of a number of times each word appears in the image; and
sum all weights of cells of the histogram thereby providing a score for the fern.

4. The system of claim 3 further including wherein the processor is operable to compare each cell of the histogram to a threshold and wherein the sum of all weights comprises all weights of all cells over the threshold.

5. The system of claim 3 wherein for the classifier includes multiple lookup ferns, calculation of multiple binary features and concatenation of the set of binary features is repeated for each lookup fern, and wherein a sum the weights of the multiple lookup ferns scores is provided.

6. The system of claim 2 wherein the sample image data may include multiple channels, a first channel comprising said depth data and a second channel comprising IR data, and wherein the learned model is provided by analysis of the first set of training data including a plurality of training images, the processor operable to:
select an offsets and channels for each bit in each fern for the training image; and
assign a weight to each entry of each lookup fern for the training image.

7. The system of claim 6 wherein, for a single lookup fern, the processor is operable to create a binary vector for each training image by:
extracting binary features comparing pairs of pixels in each training image with one or more data channels based on two offsets and a channel for each feature;
evaluating the binary features by shifting a set of reference points; and
comparing the count of binary features to a threshold for every histogram bin.

8. The system of claim 6 wherein the learned model is adapted to maximize an information gain criterion, the learned model created by:
randomizing reference points by selecting at random a patch from a group of patches within the first set of training data and setting reference points to at least a subset of locations within the patch selected;
constructing binary features that compare pixels within the patch by, first, setting all binary features to return 0 constantly;
then, for every binary feature, randomizing a set of candidate binary features and for every candidate, setting a current binary feature to a candidate and consider possible combinations of thresholds for histogram bins and evaluate corresponding binary mappings for all images in the training set;
calculate the maximum information gain for binary features mappings of each candidate; and
set current binary feature to the candidate that achieved maximum information gain.

9. The system of claim 8 wherein a plurality of lookup ferns is provided and the randomizing reference points, comparing binary features and randomizing a set of candidate binary features is repeated for every lookup fern where every image in the first training set is associated with a weight which is accounted for when computing maximum information gain.

10. The system of claim 3 wherein a weight is assigned to each fern lookup table entry by using at least a first set or a second set of training data to train an SVM linear classifier with the binary features and assign weights to a resulting learned model.

11. A computer implemented method of classifying sample image data to determine a gesture present in the sample image data, the method comprising:
creating a discriminative ferns ensemble classifier having direct indexing to a set of classification tables, the tables developed using a learned model based on a first set of training data and optimized by a weighting of the tables using an SVM linear classifier based on at least one of one of the first set and a second set of training data;
receiving sample image data to be classified from a capture device, the capture device including one or more input channels;
analyzing the sample image data using the discriminative ferns ensemble classifier; and
outputting a determination of the gesture in the sample image data, the determination enabling a manipulation of a natural user interface.

12. The computer implemented method of claim 11 wherein the classifier performs a method of:
calculating multiple binary features of an image in the sample image data;
concatenating a set of binary features for the image into a word;
repeating said calculating and said concatenating after shifting a reference point in the sample image data to all possible points in the sample image data;
creating a histogram comprising a count of a number of times each word appears in the image; and
summing all weights in cells of the histogram thereby providing a score for the fern.

13. The method of claim 1 wherein the sample image data may include multiple channels, a first channel comprising depth data and a second channel comprising IR data, and wherein the learned model is provided by analysis of the first set of training data including a plurality of training images, the method including steps:
selecting a offsets and channels for each bit in each training image; and
assigning a weight to each entry of each lookup fern for the training image.

14. The method of claim 13 wherein, for a single lookup fern, the method creates a binary vector for each training image by:
counting binary words composed of binary features obtained from each training image by comparing pairs of pixels at two offsets within the image channels;
evaluating the binary words by shifting a set of reference points; and
comparing the count of binary words to a threshold for every histogram bin.

15. The method of claim 12 wherein the learned model is further created to maximize an information gain criterion by:
randomizing reference points by selecting at random a patch from a group of patches within the first set of training data and setting reference points to at least a subset of locations within the patch selected;
comparing binary features of pixels within the patch by setting all binary features to return 0 constantly;
for every binary feature, randomizing a set of candidate binary features and for every candidate, setting a current binary feature to a candidate and consider possible combinations of thresholds for histogram bins and evaluate corresponding binary mappings for all images in the training set;
calculating a maximum information gain for binary features mappings of each candidate; and
assigning the current binary feature to the candidate that achieved maximum information gain.

16. A pose detection and classification system adapted to classify human poses in sample image data, comprising:
a capture device including a first input channel and a second input channel, each channel providing sample image data;
a processing device operable on the sample image data using a discriminative ferns ensemble classifier having direct indexing to a set of classification tables, the tables developed using a first set of training data and optimized by a weighting of the tables using an SVM linear classifier configured based on a second set of training data, the processing device a outputting a determination of the pose in the sample image data, the determination enabling a manipulation of a natural user interface.

17. The system of claim 16 wherein the ensemble classifier comprises code operable to instruct a processor to:
select a patch in an image in the sample image data;
calculate multiple binary features of the image in the sample image data;
concatenate a set of binary features for the image into a word;
repeat the calculate and concatenate steps after shifting a reference point for the calculate and concatenate steps to all possible points in the image;
build a histogram comprising a count of a number of times each word appears in the image; and
sum all weights of cells of the histogram thereby providing a score for the fern.

18. The system of claim 17 further including wherein the processor is operable to compare each cell of the histogram to a threshold and wherein the sum of all weights comprises a sum of all weights of all cells over the threshold.

19. The system of claim 18 wherein for the classifier includes multiple lookup ferns, calculation of multiple binary features and concatenation of the set of binary features is repeated for each lookup fern, and wherein a sum of weights of multiple lookup ferns scores is provided.

20. The system of claim 19 wherein the classification tables are adapted to maximize an information gain criterion, the classification tables created by:
randomizing reference points by selecting at random a patch from a group of patches within the first set of training data and setting reference points to at least a subset of locations within the patch selected;
learning binary features based on pixel comparisons within the patch by first setting all binary features to return zero constantly;
for every binary feature, randomizing a set of candidate binary features and for every candidate, setting a current binary feature to a candidate and consider possible combinations of thresholds for histogram bins and evaluate corresponding binary mappings for all images in the training set;
calculate the maximum information gain for binary features mappings of each candidate; and
set current binary feature to the candidate that achieved maximum information gain.
